(19) United States
(12) Patent Application Publication
(10) Pub. No.: US 2025/0216824 A1
(43) Pub. Date: Jul. 3, 2025

(54) Data-Driven State Estimation and System Control under Uncertainty

(71) Applicant: Mitsubishi Electric Research Laboratories, Inc., Cambridge, MA (US)

(72) Inventors: Wael Ali, Cambridge, MA (US); Saviz Mowlavi, Cambridge, MA (US); Mouhacine Benosman, Cambridge, MA (US)

(73) Assignee: Mitsubishi Electric Research Laboratories, Inc., Cambridge, MA (US)

(21) Appl. No.: 18/402,825

(22) Filed: Jan. 3, 2024

(51) Int. Cl. G05B 15/02

(52) U.S. Cl. CPC G05B 15/02

(57) ABSTRACT

A control method for controlling an electro-mechanical system according to a task estimates the state of the system using an adaptive surrogate model of the system to produce an estimation of the state of the system. The adaptive surrogate model includes a neural network employing a weighted combination of neural ODEs of dynamics of the system in latent space, such that weights of the weighted combination of neural ODEs represent the uncertainty. The method controls the system according to the task based on the estimation of the state of the system and tunes the weights of the weighted combination of neural ODEs based on the controlling.

### TECHNICAL FIELD

The present disclosure relates generally to system modeling, prediction and control, and more particularly to systems and methods for adaptive reduced order modeling and control of high dimensional physical systems under model and environment uncertainties using a neural network model.

### BACKGROUND

Control theory in control systems engineering is a subfield of mathematics that deals with the control of continuously operating dynamical systems in engineered processes and machines. The objective is to develop a control policy for controlling and regulating the behavior of such systems. The control policy specifies an appropriate control action at every time on the system in order to achieve a desired outcome, which is defined by a control objective function. Examples of desired outcomes specified by a control objective function include stabilizing the system or tracking a desired state trajectory while minimizing a certain cost.

A control policy may be open-loop, in which case the control action at a given time is not a function of the current state of the system. A control policy may also be closed-loop, in which case the control action at a given time is a function of the current state of the system, reconstructed in real time from physical sensors data using an estimation algorithm.

Developing a control policy consists of model-based techniques in which the physical model of a system is directly used when designing the control policy, or data-driven techniques that exploit operational data generated by a system in order to construct control policies that achieve the desired outcome.

A physical model of the dynamics of a system, or a physical model of a system, describes the dynamics of the system using ordinary differential equations (ODEs) or partial differential equations (PDEs). These ODEs or PDEs are constructed from physical conservation laws and physical principles, and they may be linear or nonlinear. Given an initial state and an arbitrary sequence of control actions, the physical model of a system may be used to predict the future state of the system at any desired time.

Physical models are typically high-dimensional, i.e. the state of the system is described by a very large number of variables or by a continuous function of space, and suffer from incomplete knowledge leading to several sources of uncertainties in the governing equations. Examples of such systems include power networks, buildings, airflow in a room, and smart grids. For such systems, the physical model may be computationally very expensive to solve. Furthermore, the physical parameters of the model, for example, the load demand, the conductivity of the insulation material, the viscosity of the air, and wind speed, are uncertain and can be modeled as random variables and fields belonging to bounded uncertainty range that capture prior knowledge about the system and its operating conditions.

In order to reduce the computational cost of the high-dimensional physical models, surrogate models, typically constructed through repeated simulations, have been employed. A class of surrogate models includes reduced-order models that are commonly derived using a projection framework; that is, the governing equations of the physical model are projected onto a subspace of reduced dimension. This reduced subspace is defined via a set of basis vectors, which, for general nonlinear problems, can be calculated via the proper orthogonal decomposition (POD) or with reduced basis methods. Using the constructed reduced-order model as a surrogate for the high-dimensional physical model, the control policy is then designed using model-based techniques with tractable computational cost. For both approaches, the reduced basis is pre-constructed using full forward problem simulations. However, care must be taken to ensure efficient construction and solution of the reduced-order models as sufficient forward simulations may not be available for high-dimensional systems.

On the other hand, data-driven techniques that exploit operational data generated by a system have been used to construct control policies that achieve the desired outcome. A drawback of such methods is the potential requirement for large quantities of data and the lack of performance guarantees when the state of the system during operation differs from the states present in the data used to construct the control policy.

In order to address the aforesaid challenges in model-based and data-driven techniques, operator learning models of the physical system have been proposed. Such models yield a surrogate of the physical system that describes the dynamics using a neural network model with a lower computational cost. To address the data-intensive requirements of neural network models, the physical model, represented by PDEs, can be incorporated into the training process. The advantage is that the resulting operator learning model may require less training data since it learns to satisfy the physical conservation laws that govern the dynamics of the system. However, the conventional optimization framework used for training operator learning models does not accurately quantify parametric uncertainties associated with the incomplete knowledge of the system. Thus, operator learning models constructed with these methods may not display sufficient accuracy and robustness to ensure good performance of model-based control policies across all operating conditions.

To that end, there exists a need for a method and a system for incorporating uncertainties into an operator learning model leading to adaptive and robust surrogate models, so that a control policy based on this model may be (i) effective at controlling high-dimensional systems, and (ii) robust at capturing state trajectories following significant system disturbances and/or across all operating conditions.

### SUMMARY

It is an objective of different embodiments to provide a computer-implemented method and a system for training, deploying, and/or adapting an operator-learning surrogate model of a high-dimensional dynamical system under parametric uncertainties. It is another objective of some embodiments to provide an adaptive surrogate model of a high-dimensional dynamical system learned using physics-informed training under parametric uncertainties. Some embodiments tackle these uncertainties by formulating the adaptation of the operator-learning as a weighted, e.g., polytopic, representation of such surrogate models.

Specifically, some embodiments are based on realizing that different surrogate models can be learned for different values of the parameters, and an ultimate surrogate model, i.e., the model used to complete a task, is a weighted combination of these models. In addition, some embodiments are based on realizing that such weights can be tuned online during the execution of the task, e.g., as part of a feedback loop or as a dedicated tuning, e.g., using an online estimator, such as a Kalman filter. This allows to separate computationally demanding training performed offline, from lightweight tuning performed online during an execution of a task by a system with uncertained parameters.

Parameters of the system having uncertainty should not be confused with optimization variables of the dynamic of the system optimized during the control. To illustrate the problem addressed by some embodiments, an example of such a task is a robot arm moving between two points according to the reference trajectory. While optimization variables could be positions and/or velocities of the robotic arm, the uncertainty affecting the dynamics of the movement of the arm of the robot can include uncertainty about the mass of the arm carrying an object. For example, the mass of the arm can have one of several values. To address this uncertainty, the embodiments determine surrogate models for different possible values of the mass of the robot arm and use a weighted combination of these surrogate models during the control of the robot with weights updated based on feedback from the control.

Another example of a system with uncertainty is controlling a train having dynamics that include an uncertainty about friction between the wheels and the rails. Another example of a system with uncertainty is controlling an air-conditioning system under the uncertainty of a current heat load or the temperature of the ambient air.

However, some embodiments are based on recognizing that if regular architectures of neural networks are used as a structure for building surrogate models for dynamical systems, there will be a need for a large number of neural network layers. To address this problem, some embodiments use neural ODEs trained for different parameters within a boundary of parametric uncertainties such that the model used to perform a task on a system includes a weighted, e.g., polytopic, combination of the neural ODEs. While a neural network is defined by a fixed architecture with a set number of layers, the neural ODEs allow the depth of the network to be a dynamic function of the input data, which is advantageous to represent the dynamics of the system.

In addition, in order to reduce the computational cost of neural ODEs high-dimensional physical systems, some embodiments use reduced-order models obtained using projection onto a lower-dimensional latent space. Some embodiments are based on projection using an autoencoder architecture that includes an encoder neural network, a nonlinear propagator including a neural ODE, and a decoder neural network. The encoder is configured to encode the digital representation of a high-dimensional state at an initial time into a low-dimensional latent vector that belongs to a latent space. The neural ODE propagator is configured to propagate the latent vector in latent space using a nonlinear transformation. Finally, the decoder is configured to decode the propagated latent vector in latent space back to a digital representation of the high-dimensional state.

Accordingly, one embodiment discloses a control method for controlling an electro-mechanical system according to a task, wherein at least one of parameters of the system includes an uncertainty, wherein the method uses a processor coupled with stored instructions implementing the method, wherein the instructions, when executed by the processor carry out steps of the method, comprising: estimating a state of the system using an adaptive surrogate model of the system to produce an estimation of the state of the system, wherein the adaptive surrogate model includes a neural network employing a weighted combination of neural ODEs of dynamics of the system in latent space, such that weights of the weighted combination of neural ODEs represent the uncertainty; controlling the system according to the task based on the estimation of the state of the system; and tuning the weights of the weighted combination of neural ODEs based on the controlling.

In some implementations, the weighted combination is a polytopic weighted combination of neural ODEs of dynamics of the system in latent space.

Another embodiment discloses a controller for controlling an electro-mechanical system according to a task, wherein at least one of parameters of the system includes an uncertainty, wherein the controller comprises a processor; and a memory having instructions stored thereon that, when executed by the processor, causes the controller to: estimate a state of the system using an adaptive surrogate model of the system to produce an estimation of the state of the system, wherein the adaptive surrogate model includes a neural network employing a weighted combination of neural ODEs of dynamics of the system in latent space, such that weights of the weighted combination of neural ODEs represent the uncertainty; control the system according to the task based on the estimation of the state of the system; and tune the weights of the weighted combination of neural ODEs based on the control.

Yet another embodiment discloses a non-transitory computer-readable storage medium embodied thereon a program executable by a processor for performing a control method for controlling an electro-mechanical system according to a task, wherein at least one of parameters of the system includes an uncertainty, the method comprising: estimating a state of the system using an adaptive surrogate model of the system to produce an estimation of the state of the system, wherein the adaptive surrogate model includes a neural network employing a weighted combination of neural ODEs of dynamics of the system in latent space, such that weights of the weighted combination of neural ODEs represent the uncertainty; controlling the system according to the task based on the estimation of the state of the system; and tuning the weights of the weighted combination of neural ODEs based on the controlling.

### BRIEF DESCRIPTION OF THE DRAWINGS

FIG. 1A is a flow diagram of a method for constructing an operator learning model of a dynamical system offline, and using the polytopic operator learning model to fine-tune and control the system online, according to embodiments of the present disclosure.

FIG. 1B is a block diagram of a control method for controlling an electro-mechanical system according to a task using principles employed by embodiments described in relation to FIG. 1A.

FIG. 2A is a schematic diagram of the architecture of the polytopic operator learning model with robust auto-encoder and polytopic neural ODE propagator, according to some embodiments of the present disclosure.

FIG. 2B is a schematic diagram of the architecture of the polytopic operator learning model with polytopic auto-encoder and neural ODE propagator, according to some embodiments of the present disclosure.

FIG. 3A is a schematic diagram illustrating the first training stage of the operator learning model, according to embodiments of the present disclosure.

FIG. 3B is a schematic diagram illustrating the second training stage of the operator learning model, according to embodiments of the present disclosure.

FIG. 3C is a schematic diagram illustrating the construction of the polytopic operator leaning model, according to embodiments of the present disclosure.

FIG. 4A is a block diagram for fine-tuning the parameters of the operator learning model online in real-time, according to embodiments of the present disclosure.

FIG. 4B is a block diagram of a method for controlling an operation of a system according to a reference trajectory of a task of the operation according to some embodiments.

FIG. 5A is a block diagram illustrating online open-loop control of the operation of the dynamical system using the polytopic operator learning model, according to some embodiments of the present disclosure.

FIG. 5B is a block diagram illustrating online closed-loop control of the operation of the dynamical system using the polytopic operator learning model, according to some embodiments of the present disclosure.

FIG. 6 is a block diagram illustrating online closed-loop control of the operation of the dynamical system using the polytopic operator learning model and model adaptation, according to some embodiments of the present disclosure.

FIG. 7 is a schematic illustrating the steps executed by the probabilistic filter for estimating the state of the controlled system, according to some embodiments of the present disclosure.

FIG. 8A is a schematic of a control method using controller configured for controlling a vapor compression system, according to some embodiments of the present disclosure.

FIG. 8B is a schematic of a block diagram of a method for controlling the vapor compression system, according to some embodiments of the present disclosure.

FIG. 9 is a schematic of a method for controlling a robotic manipulator according to some embodiments of the present disclosure.

FIG. 10 is a schematic diagram of a computing device that can be used for implementing control methods of the present disclosure.

### DETAILED DESCRIPTION

In describing embodiments of the disclosure, the following definitions are applicable throughout the present disclosure. A “control system” or a “controller” may be referred to a device or a set of devices to manage, command, direct or regulate the behavior of other devices or systems. The control system can be implemented by either software or hardware and can include one or several modules. The control system, including feedback loops, can be implemented using a microprocessor. The control system can be an embedded system.

A “central processing unit (CPU)” or a “processor” may be referred to a computer or a component of a computer that reads and executes software instructions. Further, a processor can be “at least one processor” or “one or more than one processor”.

Various embodiments provide a computer-implemented method and a system for training, deploying, and adapting an operator-learning surrogate model of a high-dimensional dynamical system under parametric uncertainties. Some embodiments achieve these objectives by constructing a polytopic representation of such surrogate models and designing an online adaptation law to select the most optimal part of the polytopic model, which most accurately represents the high-dimensional system at any given time. The operator learning surrogate model may be used to estimate the future state of the system at any desired time given an initial state and an arbitrary control sequence. At inference time, measurement data is used to estimate the state and parameters of the model and adapt the dynamics according to the polytopic model construction by tuning weights of the polytopic representation.

The operator learning surrogate model possesses an autoencoder architecture that includes an encoder neural network, a nonlinear propagator including a neural ODE, and a decoder neural network. The encoder is configured to encode the digital representation of a high-dimensional state at an initial time into a low-dimensional latent vector that belongs to a latent space. The neural ODE propagator is configured to propagate the latent vector in latent space using a nonlinear transformation. Finally, the decoder is configured to decode the propagated latent vector in latent space back to a digital representation of the high-dimensional state.

In some implementations, the computer-implemented method includes collecting a digital representation of the sequence of high-dimensional states of the system at different instances of time during its operation, and for all possible parameter combinations within the bounded uncertainty ranges corresponding to the various operating conditions. In addition, a digital representation of the time series of control action values given to the system during its operation may be available. This collection is carried out multiple times, starting from different state initial conditions, different parameter vector realizations, and using time series of control action values. For a given initial condition of the state and parameter vector realization, the sequence of states at different time instances and the time series of control action values are referred to as a solution trajectory. The ensemble of collected solution trajectories is referred to as the training set. In some embodiments, the training set is divided into several sets that correspond to each parameter vector realization, which are referred to as parametric training sets. In other embodiments, the training set includes all trajectories and is referred to as the robust training set.

For example, the computer-implemented training of the operator learning model can be performed in two stages. In the first training stage, the encoder and decoder are trained to compress high-dimensional states into low-dimensional latent vectors and vice-versa. To this effect, at each training iteration, the sequence of high-dimensional states belonging to a randomly sampled solution trajectory in the training set is given as input to the encoder, which outputs a corresponding sequence of low-dimensional latent vectors. These latent vectors are then given as input to the decoder, which outputs a corresponding sequence of high-dimensional states. The loss then penalizes the mean square error between the sequence of states returned as output by the decoder and the ground truth sequence of states given as input to the encoder.

In some embodiments, the set of solution trajectories used to train the encoder and decoder includes the collection of all trajectories obtained for all possible initial conditions and parameter realizations, i.e. the robust training set. In this robust training, the encoder-decoder network constructs a low-dimensional latent vector representation corresponding to any parameter realization without explicit dependence on the parameters. In other embodiments, the encoder-decoder network has an explicit dependence on the parameters. A library of encoder-decoder networks is then built for each individual parameter vector realization by using the corresponding parametric training set, and the latent vector representation is then constructed as an adaptive polytopic representation of these individual networks.

In the second training stage, a library of neural ODE propagators is trained to learn the dynamics of the system in the latent space. To this effect, each solution trajectory in the parametric training sets is first mapped to the latent space by passing its high-dimensional state sequence to the encoder, resulting in a corresponding ground truth latent vector sequence. Then, at each training iteration, the ground truth initial latent vector and the time series of control action values corresponding to a randomly sampled trajectory are given to the parametric neural ODE propagator, which returns the corresponding latent vector sequence. The loss then penalizes the mean square error between the latent vector sequence predicted by the neural ODE propagator and the ground truth latent vector sequence at the corresponding parameter vector realization. In this adaptive approach, the neural surrogate model has an explicit dependence on the parameters, and at inference time, an adaptive polytopic representation of the individual ODE propagators is used where the parameter-dependent weights dictate the contribution of each propagator.

At inference time, this parameter-dependent polytopic representation of the encoder-decoder network and/or the neural ODE propagator allows the formulation of an adaptive online estimator for systems governed by high-dimensional PDEs with parametric uncertainties. In particular, the embodiments of this invention enable parameter-state estimation using a surrogate model with an online adaptation law allowing interpolation between the learned dynamics captured by the library of neural ODE propagators.

In some embodiments, the parameter-state estimation is done using a modular dual algorithm that combines that adaptive polytopic operator learning model with two nonlinear data assimilation filters (e.g. particle filter, Kalman filter families including unscented Kalman filter (KF), extended KF, ensemble KF, etc.) that separately estimate the state and the unknown parameters. In other embodiments, both the state and parameters are jointly estimated with a single nonlinear filter where the state is augmented by the uncertain parameters.

In some embodiments, the uncertain parameters considered are the coefficients of PDE terms describing the dynamical model. These parameters may be low-dimensional and can be directly used to construct the polytopic representation, while in other embodiments, these parameters are high-dimensional or may themselves be stochastic space- and/or time-varying fields which are first reduced to a low-dimensional latent representation using an encoder-decoder network. In other embodiments, these parameters further include the boundary conditions of the governing PDE. In other embodiments, these parameters further include the geometry of the physical domains of the high-dimensional system.

In some embodiments, the training set of solution trajectories is obtained by a numerical solver, which solves the PDEs defined by the physical model of the system. For example, if the system of interest is airflow in a room with air conditioning control, computational fluid dynamics (CFD) simulations may be used to calculate solution trajectories. CFD simulations resolve the physical Navier-Stokes equations governing the motion of fluid flows in order to obtain the sequence of states corresponding to an initial state and an arbitrary sequence of control actions.

In some embodiments, the method further comprises incorporating the physical model, represented by PDEs, into the second training stage for the neural ODE propagator. In that case, the loss comprises an additional physics-informed term that penalizes the mean square error between the time derivative of the latent vector predicted by the neural ODE and the ground truth time derivative coming from the PDEs defined by the physical model. The second part can be evaluated on latent vectors corresponding to states in the training set trajectories, or it can be evaluated on latent vectors corresponding to arbitrary states that satisfy the boundary conditions or other constraints associated with the system. Such incorporation of the physical model into the method of training results in a physics-informed operator learning model.

In some embodiments, the method further comprises generating control commands to control the system using a model-based control policy, where the model used to design the control policy is the trained operator learning surrogate model.

In some embodiments, the method further comprises generating control commands to control the system based on a hybrid model-based and reinforcement learning control policy, where the model used to design the control policy is the trained operator learning surrogate model. Starting from a model-based control policy as a warm start, the hybrid model-based and reinforcement learning approach iteratively refines the parameters of the policy to achieve better control performance by alternating between collecting data using the current control policy and updating the policy parameters to improve the cost objective of interest.

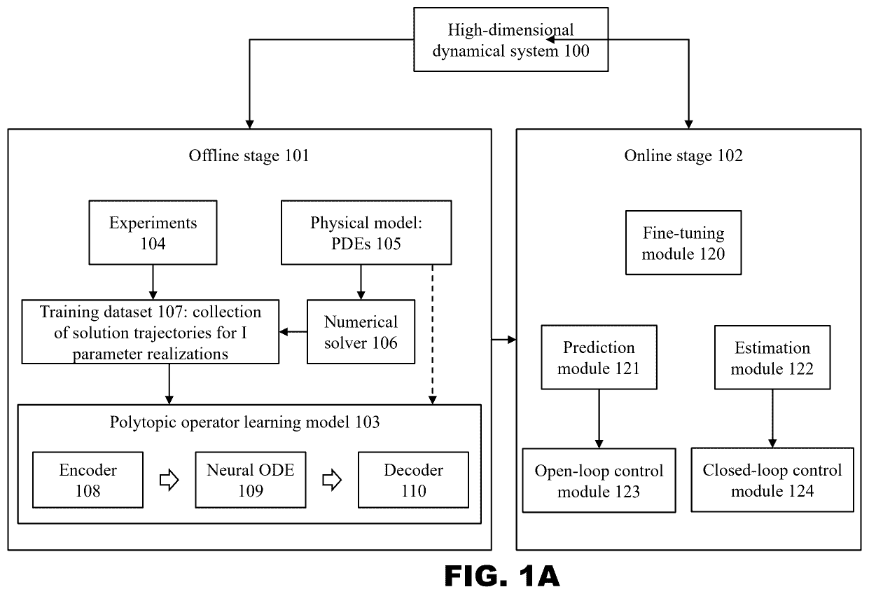

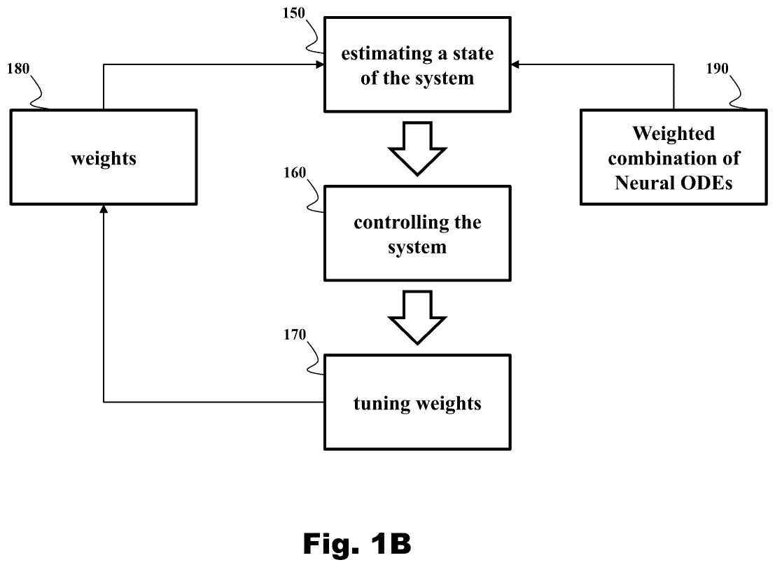

FIG. 1 is a flow diagram of a method for constructing a surrogate polytopic operator learning model 103 of a high-dimensional dynamical system 100 in an offline stage 101 and using the polytopic operator learning model to fine-tune and/or control the system in an online stage 102, according to some embodiments of the present disclosure. The physical model of the system may be described by PDEs. In some embodiments, the system may possess control inputs.

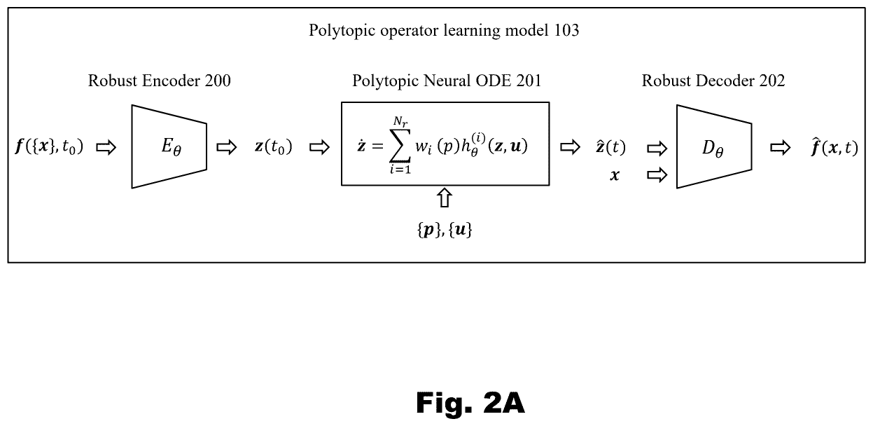

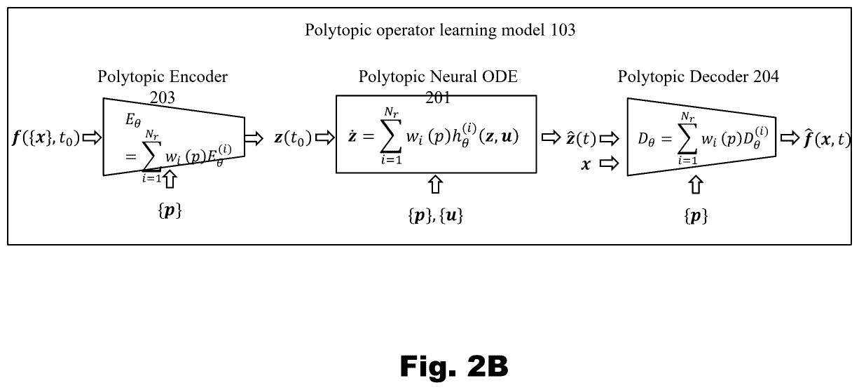

The offline stage 101 includes a polytopic operator learning model 103. The polytopic operator learning model 103, is described in FIG. 2A and FIG. 2B, comprises an encoder neural network 108, a neural ODE 109, and a decoder neural network 110. The offline stage 101 may further include an experiments module 104, a physical model 105 describing the dynamics of the system 100 using ODEs or PDEs, a high-fidelity numerical solver module 106, and a training dataset 107 consisting of a collection of solution trajectories of the system. Each solution trajectory includes an initial condition for the state, a time series of control action values, and the resulting sequence of states at different time instances during the operation of the system 100 corresponding to a realization of the uncertain parameter vector. For example, a solution trajectory for airflow in a room might describe the velocity and temperature fields at different times as they evolve from an initial condition due to forcing from an HVAC unit. The online stage 102 may include a fine-tuning module 120, a prediction module 121, an estimation module 122, an open-loop control module 123, and a closed-loop control module 124 to control the system 100 during its online operation.

The encoder neural network 108, the neural ODE 109, and the decoder neural network 110 may include fully connected neural networks (FNN) or convolutional neural networks (CNN) whose parameters are trained offline and tuned online based on the computer-implemented method of the present disclosure. In the offline stage 101, the method trains the polytopic operator learning model 103 using the solution trajectories contained in the training dataset 107 which consists of a collection of trajectories obtained using Nᵣ parameter realizations. The training determines the parameter values of the polytopic operator learning model 103 so that it can predict the evolution of the state of the system 100 given an initial condition for the state and a time series of control action values.

The method of the present disclosure improves the prediction performance over the current state-of-the-art in the presence of parametric uncertainties by constructing a polytopic representation of such models and designing an online adaptation law to select the most optimal part of the polytopic model, which most accurately represents the high-dimensional system at any given time. Furthermore, in some embodiments, the polytopic operator learning model 103 may additionally be trained using the physical model 105, in such a way that the system dynamics predicted by the polytopic operator learning model 103 respect the PDEs describing the physical model 105. In the online stage 102, according to some embodiments, the method may fine-tune the polytopic operator learning model 103 using sensor measurements obtained from the online operation of the real system by enabling joint state-parameter estimation and adaptive model switching and interpolation.

In some applications, the usage of a surrogate operator learning model 103 instead of the physical model 105 of the system 100 may be advantageous. For example, solving the physical model 105 accounting for parametric uncertainties may be computationally intractable on platforms with limited computing capability such as embedded and autonomous devices. For instance, in an HVAC system, solving the physical model means solving the Navier-Stokes equations on a fine grid in real-time, and accounting for model uncertainties such as the viscosity coefficient and the number of people in the room requires multiple model simulations which may exceed the computing capabilities of the CPU of the HVAC system. On the other hand, solving the surrogate polytopic operator learning model 103 may be computationally cheaper. Finally, even when solving the physical model 105 may be possible (e.g., by utilizing a remote cluster), executing control over the resulting model, which is an end goal for an HVAC system, may still be intractable. Indeed, executing control may require multiple iterative evaluations of the physical model 105 at each time step.

The computer-implemented method of the present disclosure may include collecting the solution trajectories contained in the training dataset 107. The solution trajectories contained in the training dataset 107 may be generated by performing experiments using the experiments module 104 or by computing numerical solutions of the physical model 105 using the high-fidelity numerical solver module 106 for all the possible I parameter realizations.

In some embodiments, the numerical solver module 106 may consist of a computational fluid dynamics (CFD) solver, which utilizes numerical analysis and data structures to solve the Navier-Stokes equations governing the dynamics of fluid flows. For example, computers may be used to perform calculations required to simulate the flow of a fluid as it interacts with surfaces defined by boundary conditions. Further, multiple software solutions are used by some embodiments to provide good accuracy in complex simulation scenarios associated with transonic or turbulent flows that may arise in applications, such as in HVAC applications to describe the airflow in a room with an HVAC. Initial validation of such software may typically be performed using experimental data. In addition, previously performed analytical or empirical analysis of a particular problem related to the airflow associated with the system may be used for comparison in the CFD simulations.

In the online stage 102, the polytopic operator learning model 103 may be utilized with one or a combination of the open-loop control module 123 or the closed-loop control module 124 to control the system 100, according to some embodiments of the present disclosure. Since the polytopic operator learning model 103 learns the dynamics of the system 100 for the various parameter realizations, it may be used to predict the evolution of the state or control the operation of the system beyond the time horizon of the solution trajectories present in the training dataset 107. In addition, it allows accurate and efficient model switching and interpolation when the parameter realization is not included in the training dataset 107.

The open-loop control module 123 contains an open-loop control policy that generates commands to control the operation of the system 100 in order to achieve a desired outcome defined by a control objective function. The prediction module 121 may be used to generate trajectories of the state of system 100, which may then be utilized by the open-loop control module 123 to generate optimal control actions.

Additionally or alternatively, the closed-loop control module 124 contains a closed-loop control policy that generates commands to control the operation of the system in order to achieve a desired outcome defined by a control objective function, where each control command is computed based on the current estimated state of the system 100. The estimation module 122 may be used to carry out parameter-state estimation allowing for adaptation of the polytopic model based on a history of noisy sensor measurements up to the current time, which may then be utilized by the closed-loop control module 124 to generate optimal control actions.

For example, for a room controlled by an HVAC system, sensors may record data such as temperature, velocity, and humidity at specific locations. The estimation module may then be used to reconstruct in real-time the spatial distribution of temperature and velocity in the room based on the sensor measurements. The reconstructed models of temperature and velocity may then be utilized by the control module 124 to generate HVAC control actions in order to achieve the desired distribution of velocity and temperature in the room.

FIG. 1B shows a block diagram of a control method for controlling an electro-mechanical system according to a task using principles employed by embodiments described in relation to FIG. 1A. The method uses a processor coupled with stored instructions implementing the method, wherein the instructions, when executed by the processor carry out steps of the method.

The method includes estimating 150 a state of the system using an adaptive surrogate model of the system including a weighted combination 190 of neural ODEs of dynamics of the system in latent space to produce an estimation of the state of the system. In some implementations, the weighted combination 190 is a polytopic weighted combination of neural ODEs of dynamics of the system in latent space.

In various embodiments, at least one of the parameters of the system includes an uncertainty represented by weights 180 of the weighted combination of neural ODEs. Hence, to reduce the uncertainty, the method includes controlling 160 the system according to the task based on the estimation of the state of the system and tuning 170 weights 180 of the weighted combination based on feedback from the controlling.

FIG. 2A is a schematic diagram of the architecture of the polytopic operator learning model 103 with robust auto-encoder (200 and 202) and polytopic neural ODE propagator 201, according to some embodiments of the present disclosure. The robust encoder neural network 200 is denoted by E_{θ}, the neural network defining the polytopic neural ODE 201 is denoted by h_{θ}, the robust decoder neural network 202 is denoted by D_{θ}, and θ refers to the trainable parameters of all three neural networks. In some embodiments, the state of the system is described by a continuous function of space denoted as f(x,t), where f is a physical quantity, x is a spatial coordinate, and t is time. For example, for airflow in a room, f(x,t) may represent the spatial distribution of velocity and temperature in the room at time t. Starting from an initial condition f(x,t₀) for the state at initial time to, and given a time series of control action values u(t′), t₀≤t′≤t the polytopic operator learning model 103 may be used to predict the future state \hat{f}(x,t) of the system at an arbitrary time t as follows. First, f({x},t₀), a digital representation of the initial condition sampled at a finite number of spatial locations {x} is given as input to the robust encoder 200, which outputs a low-dimensional latent vector at initial time

z(t₀)=E_{θ}(f({x},t₀)).

The latent vector is then passed to the polytopic neural ODE 201, which represents the dynamics of the latent vector using a polytopic construction of the neural ODEs defined through the neural networks h_{θ}⁽ⁱ⁾, i=1, . . . , Nᵣ as

$$\dot{z} = {\sum }_{i = 1}^{{N}_{r}} {w}_{i} ( p ) {h}_{θ}^{( i )} ( z , u ) ,$$

Where wᵢ are weight functions that depend on the model parameter p assumed known or later estimated as part of the estimation algorithm, and u are the control action values.

By integrating the polytopic neural ODE 201 from t₀ to t, the latent vector \hat{z}(t) is obtained. The robust decoder 202 is a neural network that takes \hat{z}(t) and an arbitrary spatial location x as input, and outputs

\hat{f}(x,t)=D_{θ}(\hat{z}(t),x),

which is an approximation of the true state f(x,t). By taking x as an input, the robyst decoder 202 produces a continuous representation \hat{f}(x,t) of the continuous state f(x,t). Such parametrization of continuous functions using neural networks are called implicit neural representations.

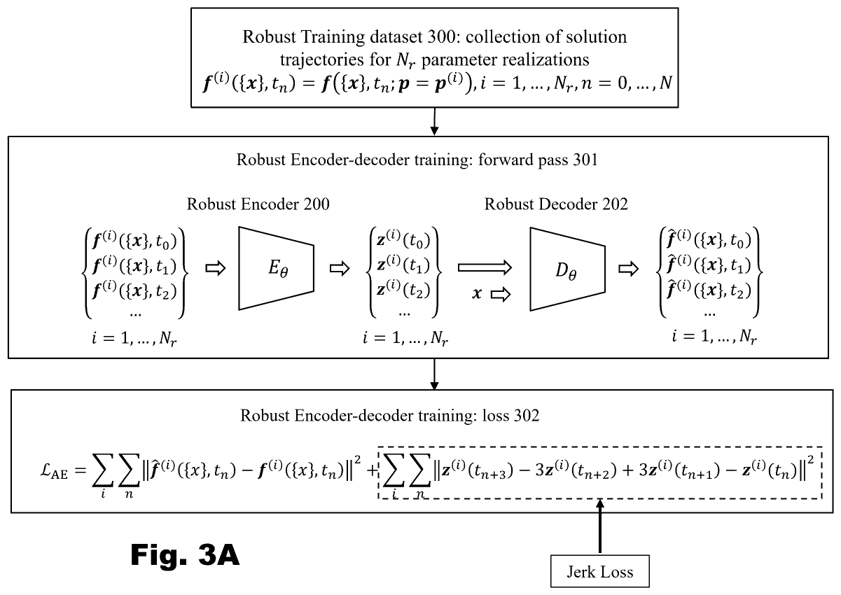

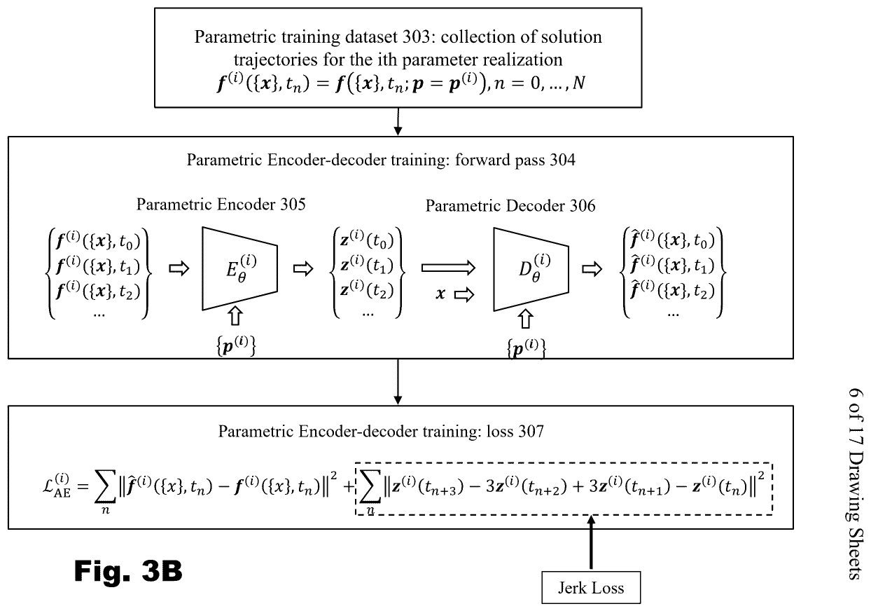

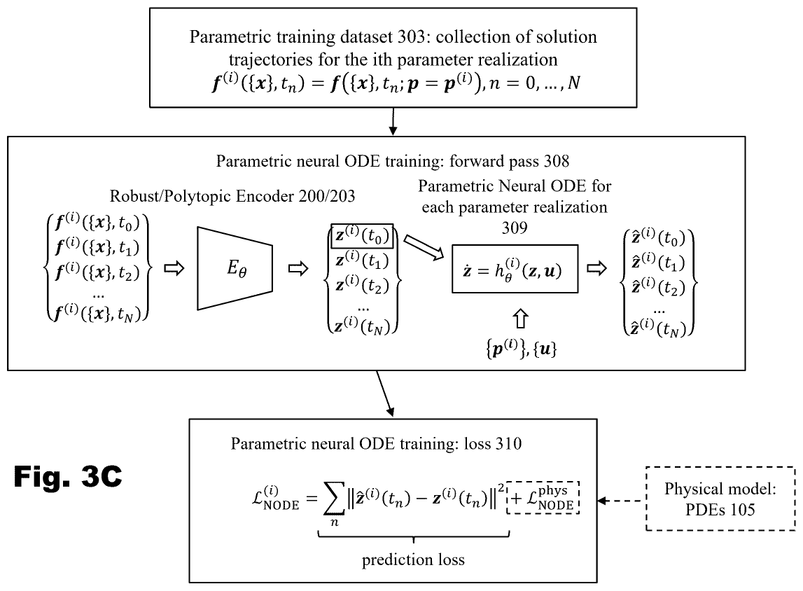

The computer-implemented method of the present disclosure trains the polytopic operator learning model 103 in a two-stage procedure described in FIGS. 3A, and 3C. This two-step training procedure determines the parameter values θ of the robust encoder neural network 200 (E_{θ}), the polytopic neural ODEs 201 (h_{θ}⁽ⁱ⁾, i=1, . . . , I), and the robust decoder neural network 202 (D_{θ}), in order for f(x,t) to be an accurate approximation of the true state f(x,t) at time t, starting from an arbitrary initial condition f(x,t₀) and given an arbitrary time series of control action values u(t) and an estimate of the model parameter p.

We denote the solution trajectories in the training dataset 107 by {f⁽ⁱ⁾({x},tₙ)}ₙ₌₀^{N}={f({x},tₙ; p=p⁽ⁱ⁾)}ₙ₌₀^{N}, where i=1, . . . , Nᵣ refers to one of Nᵣ different solution trajectories in the training dataset corresponding to the parameter realization p=p⁽ⁱ⁾, and t₀, . . . , t_{N} are the time instances at which the state is sampled at a finite number of spatial locations {x}. Together with each solution trajectory is also stored a time series of control action values u⁽ⁱ⁾(t′) for i=1, . . . , Nᵣ and t₀≤t′≤t_{N}.

FIG. 2B is a schematic diagram of the architecture of the polytopic operator learning model 103 with polytopic auto-encoder (203 and 204) and polytopic neural ODE propagator 201, according to some embodiments of the present disclosure. In addition to the polytopic neural ODE propagator discussed in the previous figure, other embodiments of this invention can include a polytopic representation for the auto-encoder. In this case, the low-dimensional latent vector is obtained from the digital representation of the initial condition using the polytopic encoder 203 as

$$z ( {t}_{0} ) = {\sum }_{i = 1}^{{N}_{r}} {w}_{i} ( p ) {E}_{θ}^{( i )} ,$$

where E_{θ}⁽ⁱ⁾, i=1, . . . , Nᵣ correspond to the parameter-dependent encoder neural networks.

Similarly, the polytopic decoder 204 is a polytopic construction of neural networks that takes \hat{z}(t) and an arbitrary spatial location x as input, and outputs

$$\hat{f} ( x , t ) = {\sum }_{i = 1}^{I} {w}_{i} ( p ) {D}_{θ}^{( i )} ( \hat{z} ( t ) , x ) .$$

The procedure used to train the polytopic encoder 203 and decoder 204 is further described in relation to FIG. 3A and FIG. 3B.

FIG. 3A illustrates the first stage of training the polytopic operator learning model 103 for the case of robust auto-decoder (200 and 202) and polytopic neural ODE 201, according to some embodiments of the present disclosure. The first stage determines the parameter values θ of the robust encoder neural network 200 (E_{θ}) and the robust decoder neural network 202 (D_{θ}). The goal is that the trained encoder is able to compress a continuous state f(x,t) into a low-dimensional latent vector z(t), and that the trained decoder is able to decompress the low-dimensional latent vector z(t) back to the same continuous state f(x,t). For training, a robust training dataset 300 is built by considering all trajectories for all parameter vector realizations, i.e. {f⁽ⁱ⁾({x},tₙ)}ₙ₌₀^{N}, i=1, . . . , Nᵣ. Each training iteration comprises a forward pass 301 where an entire solution trajectory {f⁽ⁱ⁾{x}, tₙ)}ₙ₌₀^{N} for a given i is drawn from the training dataset 300, and given as input to the robust encoder 200. The robust encoder 200 then outputs the corresponding trajectory of low-dimensional latent vectors as

$${\{ {z}^{( i )} ( {t}_{n} ) \}}_{n = 0}^{N} = {E}_{θ} ( {\{ {f}^{( i )} ( \{ x \} , {t}_{n} ) \}}_{n = 0}^{N} ) .$$

This trajectory of low-dimensional latent vectors is then given as input to the robust decoder 202, which outputs a trajectory of reconstructed system states

$${\{ {\hat{f}}^{( i )} ( x , {t}_{n} ) \}}_{n = 0}^{N} = {D}_{θ} ( {\{ {z}^{( i )} ( {t}_{n} ) \}}_{n = 0}^{N} , x ) .$$

Putting together all the iterations for all trajectories i=1, . . . , Nᵣ, the robust training loss [symbol] _{AE} 302 is:

$${ℒ}_{AE} = {\sum }_{i} {\sum }_{n} {‖ {\hat{f}}^{( i )} ( \{ x \} , {t}_{n} ) - {f}^{( i )} ( \{ x \} , {t}_{n} ) ‖}^{2}$$

which ensures that the robust encoder 200 (E_{θ}) and the robust decoder 202 (D_{θ}) are inverse mappings of each other.

In other embodiments, another term may be added to training loss 302:

$${ℒ}_{AE} = {\sum }_{i} {\sum }_{n} {‖ {\hat{f}}^{( i )} ( \{ x \} , {t}_{n} ) - {f}^{( i )} ( \{ x \} , {t}_{n} ) ‖}^{2} + {\sum }_{i} {\sum }_{n} {‖ {z}^{( i )} ( {t}_{n + 3} ) - 3 {z}^{( i )} ( {t}_{n + 2} ) + 3 {z}^{( i )} ( {t}_{n + 1} ) - {z}^{( i )} ( {t}_{n} ) ‖}^{2}$$

The second term ensures that the low-dimensional latent vector z⁽ⁱ⁾(tⱼ) evolves smoothly from one time step to the next.

At each training iteration, the loss [symbol] _{AE} 302 is used to update the parameters θ of the robust encoder 200 and the robust decoder 202 using a gradient descent algorithm such as stochastic gradient descent or the Adam optimizer.

In some implementations, each trajectory {f⁽ⁱ⁾({x},tₙ)}ₙ₌₀^{N} maybe captured over different spatial locations {x} and time instances t₀, . . . , t_{N} as compared to the other trajectories. In this case, the loss function should be modified accordingly. To simplify the notation without loss of generality, all trajectories are assumed to be recorded at the same spatial locations and over the same time instances.

FIG. 3B illustrates the first stage of training the polytopic operator learning model 103 for the case of polytopic auto-decoder (203 and 204) and polytopic neural ODE 201, according to some embodiments of the present disclosure. In this case, the training dataset is split into parametric training sets 303 where only the trajectories obtained for each parameter vector realization are considered. The training procedure then follows the procedure explained for the previous figure to build the parameteric encoder networks 305 E_{θ}⁽ⁱ⁾, i=1, . . . , Nᵣ and parametric decoder networks 306 D_{θ}⁽ⁱ⁾, i=1, . . . , Nᵣ using the parametric encoder-decoder training loss 307

$${ℒ}_{AE}^{( i )} = {\sum }_{n} {‖ {\hat{f}}^{( i )} ( \{ x \} , {t}_{n} ) - {f}^{( i )} ( \{ x \} , {t}_{n} ) ‖}^{2} ,$$

which can be modified to additionally include the jerk loss term as follows:

$${ℒ}_{AE}^{( i )} = {\sum }_{n} {‖ {\hat{f}}^{( i )} ( \{ x \} , {t}_{n} ) - {f}^{( i )} ( \{ x \} , {t}_{n} ) ‖}^{2} + {\sum }_{n} {‖ {z}^{( i )} ( {t}_{n + 3} ) - 3 {z}^{( i )} ( {t}_{n + 2} ) + 3 {z}^{( i )} ( {t}_{n + 1} ) - {z}^{( i )} ( {t}_{n} ) ‖}^{2} .$$

FIG. 3C illustrates the second stage of training the polytopic operator learning model 103, according to some embodiments of the present disclosure. The second stage determines the parameter values θ of the parametric neural ODE propagators 309 (h_{θ}⁽ⁱ⁾, i=1, . . . , Nᵣ). The goal is that the trained Nᵣ neural ODE propagators are able to reproduce the dynamics of the latent vector z(t) in the latent space for each parameter realization p=p⁽ⁱ⁾, i=1, . . . , Nᵣ. Each training iteration includes a forward pass 308 where an entire solution trajectory {f⁽ⁱ⁾(x,tₙ)}ₙ₌₀^{N} for a given i is drawn from the parametric training dataset 303, and given as input to the robust encoder 200 or polytopic encoder 203.

The encoder then outputs a corresponding trajectory of ground-truth low-dimensional latent vectors as

$${\{ {z}^{( i )} ( {t}_{n} ) \}}_{n = 0}^{N} = {E}_{θ} ( {\{ {f}^{( i )} ( x , {t}_{n} ) \}}_{n = 0}^{N} ) .$$

The first latent vector in this trajectory, z⁽ⁱ⁾(t₀), is then given as input to the parametric neural ODE propagator 309, together with the time series of control action values for the same trajectory, u⁽ⁱ⁾(t), t₀≤t≤t_{N}. The neural ODE ż=h_{θ}⁽ⁱ⁾(z, u) is then integrated from t₀ to t_{N}, leading to a predicted latent vector trajectory \hat{z}⁽ⁱ⁾(t), t₀≤t≤t_{N}.

Each training iteration then comprises the construction of a loss [symbol] _{NODE}⁽ⁱ⁾ 310, which includes a prediction loss term that ensures that the trajectory of predicted latent vectors is similar to the trajectory of ground truth latent vectors. It is computed from the mean square error as

$${ℒ}_{NODE}^{( i )} = {\sum }_{n} {‖ {\hat{z}}^{( i )} ( {t}_{n} ) - {z}^{( i )} ( {t}_{n} ) ‖}^{2}$$

Finally, during each training iteration, the loss [symbol] _{NODE} is used to update the parameters θ of the parametric neural ODE propagator 309 using a gradient descent algorithm such as stochastic gradient descent or the Adam optimizer.

In some embodiments, the method of training the parametric neural ODE propagator 309 further includes incorporating the PDEs of the physical model 105 into the training loss [symbol] _{NODE}⁽ⁱ⁾. In this case, the method may include generating arbitrary states f({x}) sampled at a finite number of spatial locations {x}, where each state satisfies the boundary conditions and other constraints of the system. Furthermore, the states f({x}) should be physically attainable by the system. A term [symbol] _{NODE}^{phys,(i)} is then added to [symbol] _{NODE}⁽ⁱ⁾ that enforces consistency between the dynamics induced by the parametric neural ODE propagator 309 and the dynamics given by the PDEs in the physical model 105, at these states f({x}).

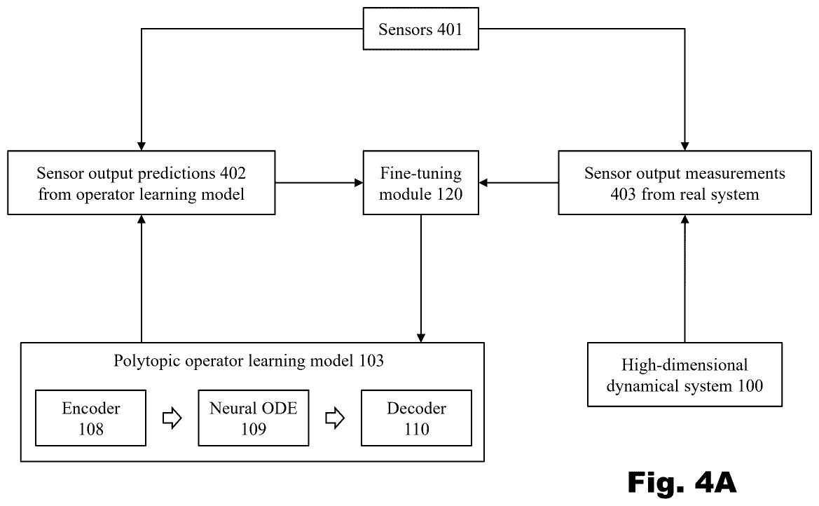

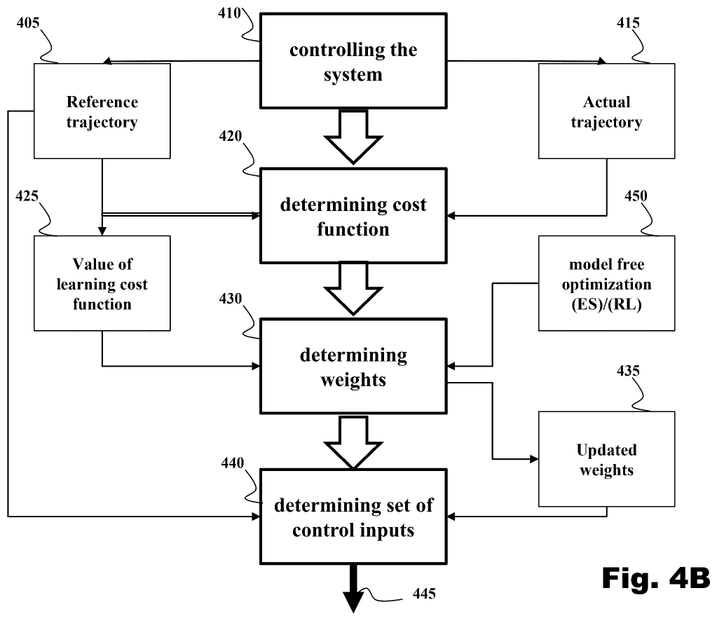

FIG. 4A is a block diagram for fine-tuning the weighted combination of the parameters of the polytopic operator learning model 103 online in real-time, according to some embodiments of the present disclosure. Sensors 401 measuring different components of the state f at various locations x during online operation may be placed in the real system 100. Once the polytopic operator learning model 103 is trained in the offline stage as described in FIG. 3A, FIG. 3B, and FIG. 3C, the polytopic operator learning model may be used to compute sensor output predictions 402 in real-time. Moreover, sensor 401 in the real system 100 may be used to obtain sensor output measurements 403 in real-time. The polytopic operator learning model 103 may then be adapted in real-time in the fine-tuning module 120 based on the difference between the sensor output predictions 402 and the sensor output measurements 403.

Various embodiments of the invention update the parameter of uncertainty during the control itself by tuning weights of the weighted combination of the neural ODEs based on feedback from the controlling. For example, the weights of the weighted combination are updated based on a difference between the estimation of the state of the system and measurements of the state of the system. In addition, it is recognized that in some cases the similarities of the control for repeated performing the task of the operation can be used to update the uncertainty for subsequent completions of the tasks. The uncertainty for the subsequent execution of the task can be updated based on the performance of the system for the current completion of the task. In some embodiments, the uncertainty is updated iteratively over multiple completions of the task to mimic the true value of the parameter of the uncertainty.

FIG. 4B shows a block diagram of a method for controlling an operation of a system according to a reference trajectory of a task of the operation according to some embodiments. The method can be implemented using a suitably programmed processor. In some embodiments, the method is used for open loop control of the tasks repeated multiple times, and the repetition of the tasks is utilized to update the weights of the polytopic combination of neural ODEs according to some embodiments.

The method controls 410 the system for multiple control steps, e.g., three or more, according to the reference trajectory 405 of the task of the operation to produce an actual trajectory 415 of the system completing the task of the operation. For each control step, a control input to the system is determined using a solution of the model-based controller employing an adaptive surrogate model of the system including a weighted combination of neural ODEs of dynamics of the system in latent space. The uncertainty of the system under control is represented by weights of the weighted combinations, and the tuning 120 updates the weights during the control.

Next, the method determines 420 a value 425 of a learning cost function of the distance between the reference trajectory and/or estimated state of the system and the actual trajectory and/or measured state of the system. The method for determining the value 425 can vary among embodiments. For example, one embodiment uses Euclidian distances between corresponding samples of the trajectories to determine the value. The sum of the Euclidian distances can be normalized to determine the value 425. Other methods for determining a tracking error can also be used.

Knowing the value 425, the method uses a model-free optimization 450 to determine 430 the weights of the weighted combination reducing the value of the learning cost function to produce an updated weights 435. Next, the method determines 440 a set of control inputs 445 for completing the task according to the reference trajectory 405 using the model including the weighted combination of neural ODEs of dynamics of the system with updated weights 435.

Some embodiments update the weights of the weighted combination to reduce the value of the learning cost function. Because the uncertainty implicitly influences the value of the learning cost function, the standard optimization methods are not used by the embodiments. Instead, some embodiments use various model-free optimization methods to update the weights. For example, one embodiment uses an extremum-seeking method, e.g., a multivariable extremum-seeking (MES). Another embodiment uses a reinforcement learning optimization. Those model-free optimization methods are usually used for optimizing the control by analyzing the real-time changes in the output of the system.

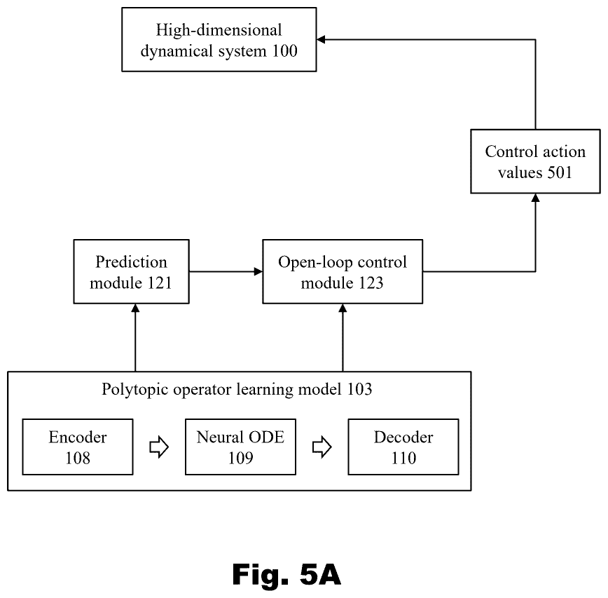

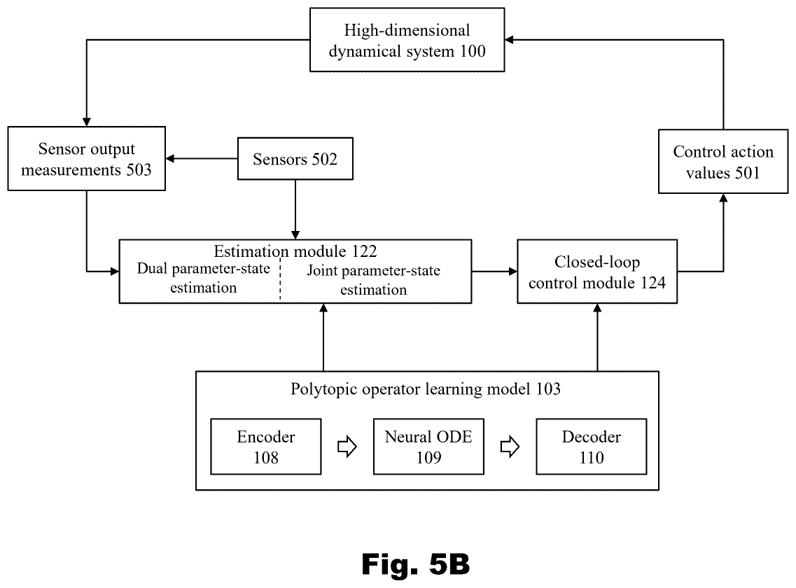

FIG. 5A is a block diagram illustrating online open-loop control of the operation of the dynamical system 100 using the polytopic operator learning model 103, according to some embodiments of the present disclosure. Once the polytopic operator learning model 103 is trained in the offline stage as described in FIG. 3A, FIG. 3B, and FIG. 3C, it may be used in a prediction module 121 to compute trajectories of the system for various initial conditions of the state, various time series of control action values, and various parameter realizations. Based on these trajectories as well as the polytopic operator learning model 103, an open-loop control policy in the control module 123 may be used to compute in real time a time series of optimal control action values 501, which may be given to control the online operation of the system 100 in order to achieve a desired outcome defined by the control objective function.

FIG. 5B is a block diagram illustrating online closed-loop control of the operation of the dynamical system 100 using the polytopic operator learning model 103, according to some embodiments of the present disclosure. Sensors 502 may be placed in the real system 100, capturing measurements 503 of different components of the state f at various locations x during the online operation of the system. Once the polytopic operator learning model 103 is trained in the offline stage as described in FIG. 3A, FIG. 3B, and FIG. 3C, it may be used in an estimation module 122 to carry out dual or joint parameter-state estimation of the system 100 based on the history of sensor output measurements 503. Based on the estimated state as well as the polytopic operator learning model 103, a closed-loop control policy in the control module 124 may be used to compute in real time a time series of optimal control action values 501, which may be given to control the online operation of the system 100 in order to achieve a desired outcome defined by the control objective function.

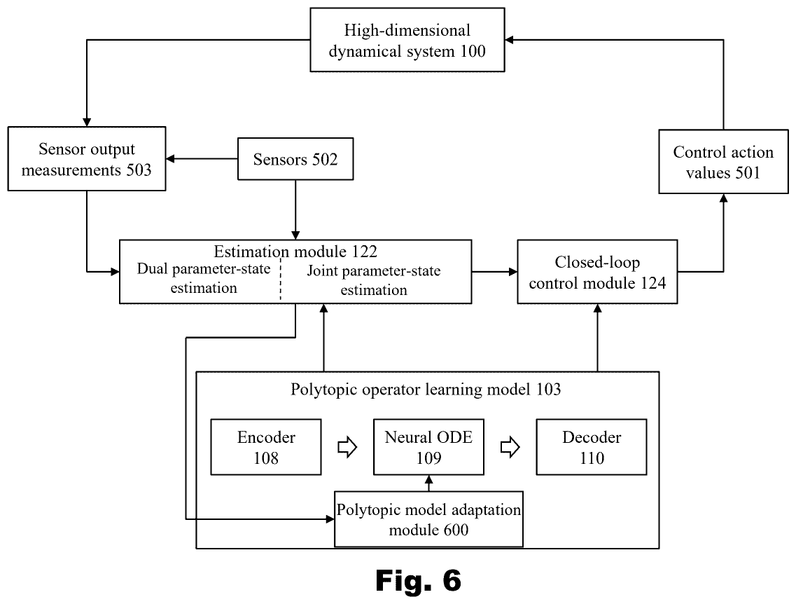

FIG. 6 is a block diagram illustrating online closed-loop control of the operation of the dynamical system 100 using the polytopic operator learning model 103 and model adaptation 500, according to some embodiments of the present disclosure. As part of the estimation module 122 used to carry out dual or joint parameter-state estimation, a polytopic model adaptation module 600 can be used to adapt the polytopical operator learning model 103 based on the estimated parameters.

For example, in some embodiments, the polytopic model adaptation module 600 updates the weights of the weighted combination using a probabilistic filter tracking the state of the system using one or a combination of a prediction model and a measurement model employing the neural network. The probabilistic filter can be used directly to track the weights of the weighted combination, and/or the state variables of the state of the system can be augmented with weights of the weighted combination and the probabilistic filter can be used to track the augmented state of the system. Examples of the probabilistic filter employed by different embodiments include one or a combination of a Kalman filter, e.g., an extended Kalman filter, and a particle filter.

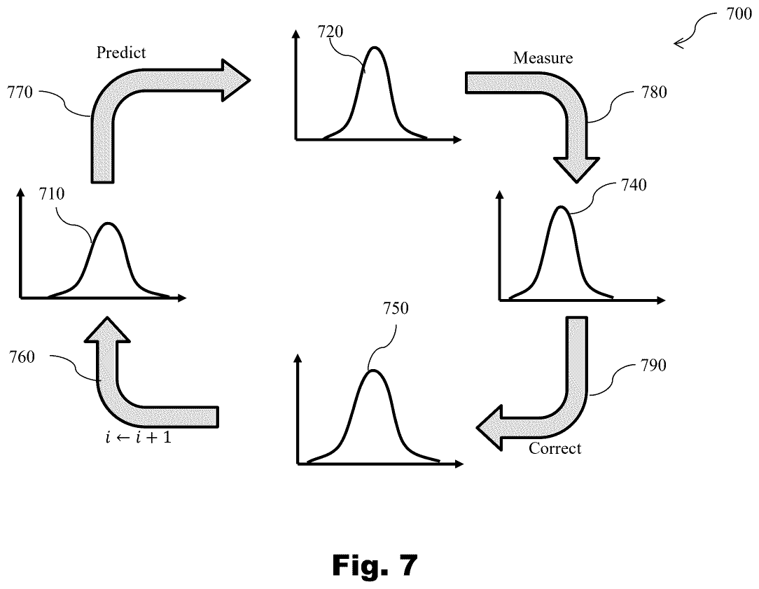

FIG. 7 shows schematic 700 illustrating the steps executed by the probabilistic filter for estimating the state of the controlled system, according to some embodiments of the present disclosure. The probabilistic filter, e.g., a Kalman filter, uses a prediction model subject to process noise and a measurement model subject to measurement noise. At least one of the prediction and measurement models includes the neural network estimating the states using a weighted combination of neural ODEs of dynamics of the system in latent space. The Kalman filter iteratively tracks the weights of the weighted combination to improve the accuracy of estimation.

The steps executed by the probabilistic filter 700 include a prediction step 770, a measurement step 780, and/or a correction step 790. In the prediction step 770, the probabilistic filter estimates a probabilistic distribution function (PDF) 720 of predicted values of the states from a PDF 710 of values of the states, using a prediction model including the neural network with the current value of weights. For instance, the PDF 720 may correspond to a Gaussian distribution. The Gaussian distribution may be defined by a mean and a variance, where the mean defines a center position of the distribution 720 and the variance defines a spread (or a width) of the distribution 720.

Referring back to FIG. 7, the measurements indicative of the outputs of the mechanical system at the current control step are used by the measurement model to produce an estimation 740 of the states of the mechanical system. The correction step 790 updates the probabilistic distribution of the states of the system 750 initializing the next iteration 760 of the probabilistic filter and/or the weights of the weighted combination. The values of the internal states used for performing a task are sampled on the distribution 750.

### EXEMPLARY EMBODIMENTS

An “air-conditioning system” or a heating, ventilating, and air-conditioning (HVAC) system may be referred to a system that uses a vapor compression cycle to move refrigerant through components of the system based on principles of thermodynamics, fluid mechanics, and/or heat transfer. The air-conditioning systems span a broad set of systems, ranging from systems that supply only outdoor air to the occupants of a building, to systems which only control the temperature of a building, to systems which control the temperature and humidity.

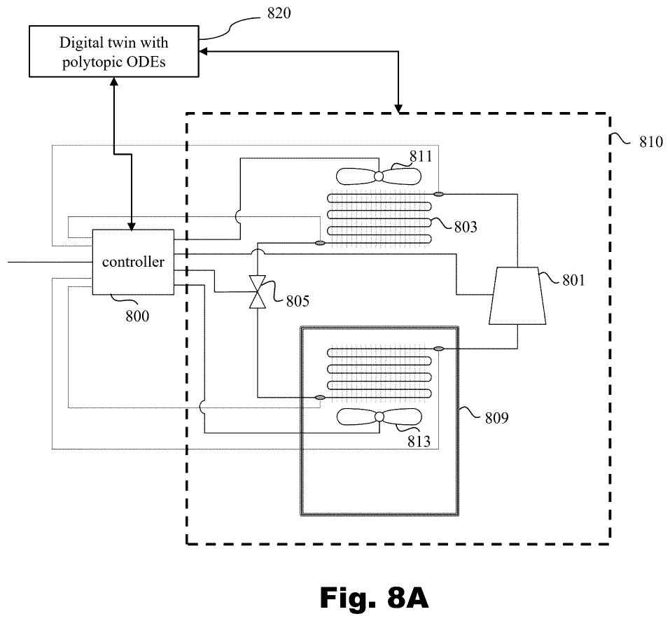

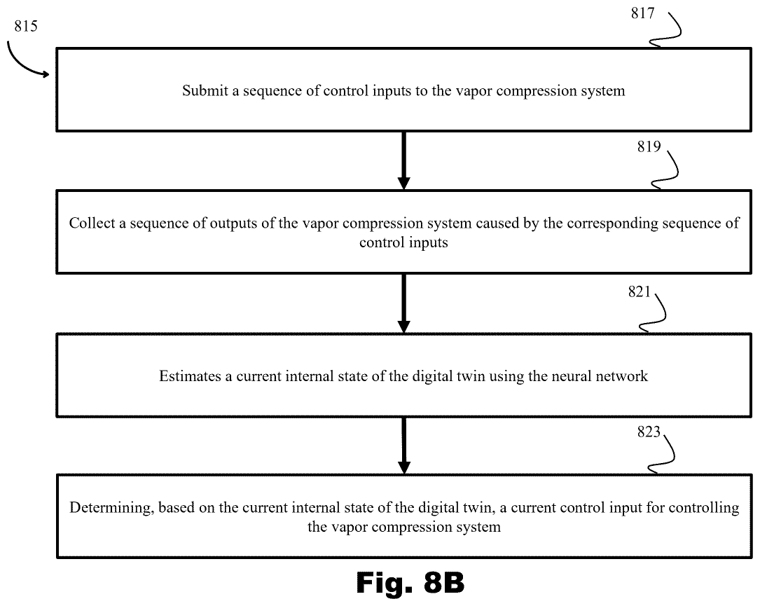

FIG. 8A illustrates a control method using controller 800 configured for controlling a vapor compression system 810, according to some embodiments of the present disclosure. The controller 800 controls the vapor compression system 810 using a digital twin 820 of the vapor compression system 810. The vapor compression system 810 and the digital twin 820 are communicatively coupled to the controller 800. The vapor compression system is configured to perform a task of maintaining an environment at a target state. The target state may include a target temperature.

The vapor compression system 810 includes a compressor 801, a condensing heat exchanger 803, an expansion valve 805, and an evaporating heat exchanger 807 located in space 809. Heat transfer from the condensing heat exchanger 803 is promoted by the use of fan 811, while heat transfer from the evaporating heat exchanger 807 is promoted by the use of fan 813. The vapor compression system 810 may include variable actuators, such as a variable compressor speed, a variable expansion valve position, and variable fan speeds. There are many other alternate equipment architectures to which the present disclosure pertains with multiple heat exchangers, compressors, valves, and other components such as accumulators or reservoirs, pipes, and so forth, and the illustration of the vapor compression system 810 is not intended to limit the scope or application of the present disclosure to systems whatsoever.

In the vapor compression system 810, the compressor 801 compresses a low-pressure, low-temperature vapor-phase fluid (a refrigerant) to a high-pressure, high-temperature vapor state, after which it passes into the condensing heat exchanger 803. As the refrigerant passes through the condensing heat exchanger 803, the heat transfer promoted by fan 811 causes the high-temperature, high-pressure refrigerant to transfer its heat to ambient air, which is at a lower temperature. As the refrigerant transfers the heat to the ambient air, the refrigerant gradually condenses until the refrigerant is in a high-pressure, low-temperature liquid state. Further, the refrigerant leaves the condensing heat exchanger 803 and passes through the expansion valve 805, and expands to a low-pressure boiling state from which it enters the evaporating heat exchanger 807. As air passing over the evaporating heat exchanger 807 is warmer than the refrigerant itself, the refrigerant gradually evaporates as it passes through the evaporating heat exchanger 807. The refrigerant leaving the evaporating heat exchanger 807 is at a low-pressure, low-temperature state. The low-pressure, low-temperature refrigerant re-enters the compressor 801, and the same VCS is repeated.

The controller 800 uses the digital twin 820 employing the weighted polytopic combination of ODEs to simulate the operation of the vapor compression system 810 and control its operations.

FIG. 8B shows a block diagram of a method 815 for controlling the vapor compression system 810, according to some embodiments of the present disclosure. At block 817, the method 815 submits a sequence of control inputs to the vapor compression system 810. The sequence of control inputs includes one or a combination of a speed of a compressor 801, a speed of the fan 813, and a position of the expansion valve 805 of the vapor compression system 810.

At block 819, the method 815 receives a sequence of outputs of the vapor compression system 810 caused by the corresponding sequence of control inputs. The sequence of outputs of the vapor compression system 810 may correspond to a sequence of measurements. Each measurement is indicative of an output of the vapor compression system 810 caused by the corresponding control input. For example, the measurements include temperature, humidity, and/or velocity of air outputted by the vapor compression system 810.

At block 821, the method 815 estimates a current internal state of the digital twin 820 using the neural network. At block 823, the method 815 determines, based on the current internal state of the digital twin 820, a current control input for controlling the vapor compression system 810. The current control input is submitted to the vapor compression system 810. The current control input changes the current state to the target state. For instance, the current control input changes a current temperature to the target temperature to perform the task of maintaining the target temperature.

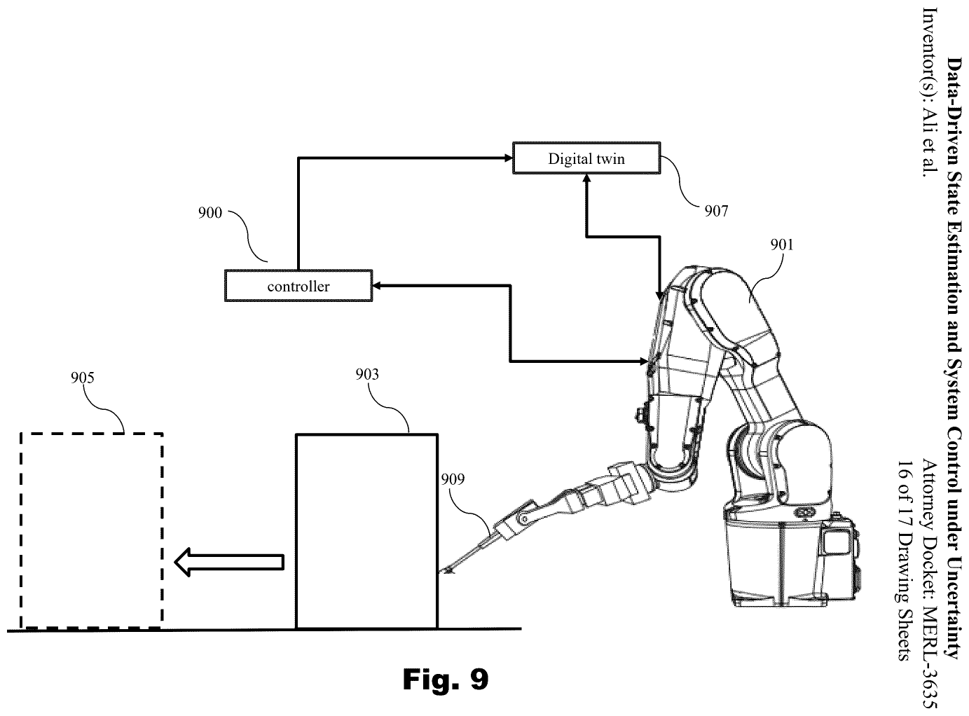

FIG. 9 illustrates a method for controlling a robotic manipulator 901 according to some embodiments of the present disclosure. The robotic manipulator 901 is configured to perform a manipulation task of moving an object 903 to a target state 905, e.g., a target location. The robotic manipulator 901 is communicatively coupled to the controller 900 and a digital twin 907 of the robotic manipulator 901. The digital twin 907 employing a polytopic combination of neural ODEs.

The controller 900 submits a sequence of control inputs to the robotic manipulator 901. The sequence of control inputs includes voltages and/or currents to actuators of the robotic manipulator 901. Further, the controller 900 collects a sequence of outputs of the robotic manipulator 901 caused by the corresponding sequence of control inputs.

Further, the controller 900 estimates a current internal state of the digital twin 907 using the neural network including a weighted combination of neural ODEs of dynamics of the robotic manipulator in latent space. Furthermore, the controller 900 determines, based on the current internal state of the digital twin 907, a current control input for controlling the robotic manipulator 901 and controls the actuators of the robotic manipulator 901 according to the current control input, causing the end-effector 909 to push the object 903 from a current state to the target state 905.

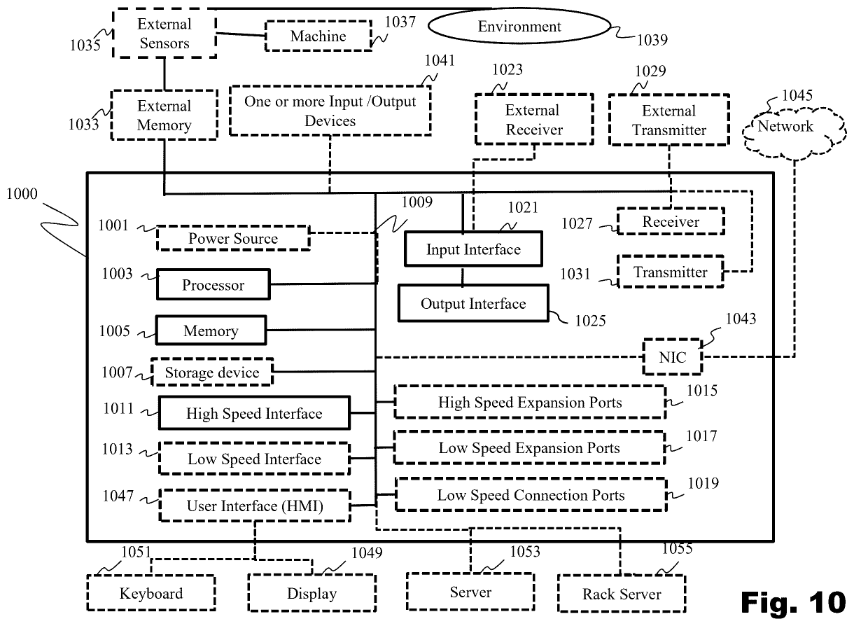

FIG. 10 shows a schematic diagram of a computing device 1000 that can be used for implementing control methods of the present disclosure. The computing device 1000 includes a power source 1001, a processor 1003, a memory 1005, a storage device 1007, all connected to a bus 1009. Further, a high-speed interface 1011, a low-speed interface 1013, high-speed expansion ports 1015 and low-speed connection ports 1017, can be connected to the bus 1009. In addition, a low-speed expansion port 1019 is in connection with the bus 1009. Further, an input interface 1021 can be connected via the bus 1009 to an external receiver 1023 and an output interface 1025. A receiver 1027 can be connected to an external transmitter 1029 and a transmitter 1031 via the bus 1009. Also connected to the bus 1009 can be an external memory 1033, external sensors 1035, machine(s) 1037, and an environment 1039. Further, one or more external input/output devices 1041 can be connected to the bus 1009. A network interface controller (NIC) 1043 can be adapted to connect through the bus 1009 to a network 1045, wherein data or other data, among other things, can be rendered on a third-party display device, third party imaging device, and/or third-party printing device outside of the computer device 1000.

The memory 1005 can store instructions that are executable by the computer device 1000 and any data that can be utilized by the methods and systems of the present disclosure. The memory 1005 can include random access memory (RAM), read only memory (ROM), flash memory, or any other suitable memory systems. The memory 1005 can be a volatile memory unit or units, and/or a non-volatile memory unit or units. The memory 1005 may also be another form of computer-readable medium, such as a magnetic or optical disk.

The storage device 1007 can be adapted to store supplementary data and/or software modules used by the computer device 1000. The storage device 1007 can include a hard drive, an optical drive, a thumb-drive, an array of drives, or any combinations thereof. Further, the storage device 1007 can contain a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, the processor 1003), perform one or more methods, such as those described above.

The computing device 1000 can be linked through the bus 1009, optionally, to a display interface or user Interface (HMI) 1047 adapted to connect the computing device 1000 to a display device 1049 and a keyboard 1051, wherein the display device 1049 can include a computer monitor, camera, television, projector, or mobile device, among others. In some implementations, the computer device 1000 may include a printer interface to connect to a printing device, wherein the printing device can include a liquid inkjet printer, solid ink printer, large-scale commercial printer, thermal printer, UV printer, or dye-sublimation printer, among others.

The high-speed interface 1011 manages bandwidth-intensive operations for the computing device 1000, while the low-speed interface 1013 manages lower bandwidth-intensive operations. Such allocation of functions is an example only. In some implementations, the high-speed interface 1011 can be coupled to the memory 1005, the user interface (HMI) 1047, and to the keyboard 1051 and the display 1049 (e.g., through a graphics processor or accelerator), and to the high-speed expansion ports 106, which may accept various expansion cards via the bus 1009.

In an implementation, the low-speed interface 1013 is coupled to the storage device 1007 and the low-speed expansion ports 1017, via the bus 1009. The low-speed expansion ports 1017, which may include various communication ports (e.g., USB, Bluetooth, Ethernet, wireless Ethernet) may be coupled to the one or more input/output devices 1041. The computing device 1000 may be connected to a server 1053 and a rack server 1055. The computing device 1000 may be implemented in several different forms. For example, the computing device 1000 may be implemented as part of the rack server 1055.

The description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments.

Further, embodiments of the present disclosure and the functional operations described in this specification can be implemented in digital electronic circuitry, in tangibly-embodied computer software or firmware, in computer hardware, including the structures disclosed in this specification and their structural equivalents, or in combinations of one or more of them. Further some embodiments of the present disclosure can be implemented as one or more computer programs, i.e., one or more modules of computer program instructions encoded on a tangible non transitory program carrier for execution by, or to control the operation of, data processing apparatus. Further still, program instructions can be encoded on an artificially generated propagated signal, e.g., a machine-generated electrical, optical, or electromagnetic signal, which is generated to encode information for transmission to suitable receiver apparatus for execution by a data processing apparatus. The computer storage medium can be a machine-readable storage device, a machine-readable storage substrate, a random or serial access memory device, or a combination of one or more of them.

According to embodiments of the present disclosure the term “data processing apparatus” can encompass all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code.

A computer program can be deployed to be executed on one computer or on multiple computers that are located at one site or distributed across multiple sites and interconnected by a communication network. Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data.

Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

Claimed is:

1. A control method for controlling an electro-mechanical system according to a task, wherein at least one of parameters of the system includes an uncertainty, wherein the method uses a processor coupled with stored instructions implementing the method, wherein the instructions, when executed by the processor carry out steps of the method, comprising:
estimating a state of the system using an adaptive surrogate model of the system to produce an estimation of the state of the system, wherein the adaptive surrogate model includes a neural network employing a weighted combination of neural ODEs of dynamics of the system in latent space, such that weights of the weighted combination of neural ODEs represent the uncertainty;
controlling the system according to the task based on the estimation of the state of the system; and
tuning the weights of the weighted combination of neural ODEs based on the controlling.

2. The control method of claim 1, wherein the weighted combination is a polytopic weighted combination of neural ODEs of dynamics of the system in latent space.

3. The control method of claim 1, wherein the weights of the weighted combination are updated based on a difference between the estimation of the state of the system and measurements of the state of the system.

4. The control method of claim 1, further comprising:
training the neural network for different values of parameters of the system, such that each of the neural ODEs is trained for a specific combination of values of the parameters of the system.

5. The control method of claim 1, wherein the adaptive surrogate model includes an autoencoder architecture having an encoder trained to encode a previous state of the system into the latent space, the weighted combination of neural ODEs trained to propagate the encoding of the previous state in time, and a decoder trained to decode the estimated state of the system from the propagated encoding of the previous state.

6. The control method of claim 5, wherein the encoder includes a weighted combination of encoders, wherein the decoder includes a weighted combination of decoders.

7. The control method of claim 6, wherein weights in the weighted combination of encoders and weights in the weighted combination of decoders equal weights in the weighted combination of the neural ODEs, such that updates of the weights in the weighted combination of the neural ODEs automatically updates the weights in the weighted combination of encoders and the weights in the weighted combination of decoders.

8. The control method of claim 5, wherein the weighted combination of neural ODEs propagates the encoding of the previous state in accordance with an input control command.

9. The control method of claim 1, wherein state variables of the state of the system are augmented with weights of the weighted combination.

10. The control method of claim 9, wherein the weights of the weighted combination are updated using a probabilistic filter tracking the augmented state of the system.

11. The control method of claim 10, wherein the probabilistic filter includes one or a combination of a Kalman filter and a particle filter.

12. The control method of claim 1, wherein the weights of the weighted combination are updated using a probabilistic filter tracking the state of the system using one or a combination of a prediction model and a measurement model employing the neural network.

13. The method of claim 12, further comprising:
executing iteratively the probabilistic filter to produce a sequence of states of the system using the prediction model subject to process noise and the measurement model subject to measurement noise, wherein at least one of the prediction model and the measurement model includes the neural network.

14. The method of claim 13, wherein the probabilistic filter is an extended Kalman filter with a model linearization obtained by differentiation of the neural network.

15. The method of claim 1, wherein the system is a robot and a parameter with uncertainty is a value of mass of a robot arm.

16. The method of claim 1, wherein the system is a train and a parameter with uncertainty is a value of friction between rails and wheels of the train.

17. The method of claim 1, wherein the system is an air-conditioning system and a parameter with uncertainty is a value of heat load or temperature of ambient air.

18. A controller for controlling an electro-mechanical system according to a task, wherein at least one of parameters of the system includes an uncertainty, wherein the controller comprises a processor; and a memory having instructions stored thereon that, when executed by the processor, causes the controller to:
estimate a state of the system using an adaptive surrogate model of the system to produce an estimation of the state of the system, wherein the adaptive surrogate model includes a neural network employing a weighted combination of neural ODEs of dynamics of the system in latent space, such that weights of the weighted combination of neural ODEs represent the uncertainty;
control the system according to the task based on the estimation of the state of the system; and
tune the weights of the weighted combination of neural ODEs based on the control.

19. The controller of claim 18, wherein the weighted combination is a polytopic weighted combination of neural ODEs of dynamics of the system in latent space.

20. A non-transitory computer-readable storage medium embodied thereon a program executable by a processor for performing a control method for controlling an electro-mechanical system according to a task, wherein at least one of parameters of the system includes an uncertainty, the method comprising:
estimating a state of the system using an adaptive surrogate model of the system to produce an estimation of the state of the system, wherein the adaptive surrogate model includes a neural network employing a weighted combination of neural ODEs of dynamics of the system in latent space, such that weights of the weighted combination of neural ODEs represent the uncertainty;
controlling the system according to the task based on the estimation of the state of the system; and
tuning the weights of the weighted combination of neural ODEs based on the controlling.
